(19) United States
(12) Patent Application Publication
(10) Pub. No.: US 2004/0154022 A1
(43) Pub. Date: Aug. 5, 2004

(54) System and method for filtering instant messages by context

(75) Inventors: Gregory J. Boss, American Fork, UT (US); Kevin C. McConnell, Austin, TX (US)

Correspondence Address: Samuel A. Kassatly, 6819 Trinidad Drive, San Jose, CA, 95120, US

(73) Assignee: International Business Machines Corporation, Armonk, NY (US)

(21) Appl. No.: 10/356,100

(22) Filed: Jan. 31, 2003

(51) Int. Cl. G06F 15/163

(52) U.S. Cl. 719/310

(57) ABSTRACT

A contextual filtering system and method allow users to define a context or set of contexts that describe the type of instant messages they are willing to receive. These contexts can be a work or interest profile in addition to a predetermined time profile. The time profile can be linked to the user's calendar, automatically restricting messages based on recipient, context, or both. A person sending an instant message matches the outgoing message to one of the recipient's contexts. The present system then delivers the message according to the recipient's profile. Through the profile, the recipient can choose whether a message is delivered immediately, delayed, rejected, or transformed according to the context profile. Transforming the message allows the user to forward the message to a third party or reply to the sender with a generic message stating, for example, that the message does not meet the recipient's active context criteria and the message will be delivered when the selected context becomes active.

### FIELD OF THE INVENTION

The present invention relates to a computer system, and more particularly to a method, system, and computer program product for filtering instant messages by context. The present invention comprises a system that could be implemented as an extension of the capabilities of instant messaging or email.

### BACKGROUND OF THE INVENTION

Currently, the two most prevalent electronic communication formats are instant messaging and e-mail. Instant messaging systems provide real-time communication between users who are connected to the systems through an on-line or electronic networking environment. Instant messaging systems are quite popular among Internet, Intranet, and Extranet users because they are user friendly and provide a simple, inexpensive way to send instantaneous messages. However, the popularity of instant messaging has created an interrupt-driven workforce. Employees often turn off instant messaging to get work accomplished; this reduces the effectiveness of a virtual knowledge organization because experts, co-workers, or friends may not be readily available.

Instant messaging is prone to being misused because no better message format appears to be available for the sender. Instant messaging has a high level of urgency implied in its delivery format, similar to a telephone call, and encourages an immediate response. However, instant messages often interrupt people at inopportune times. The only control a user has over this interruption is to specify who can and cannot send messages to the user and whether or not the user is accepting messages. Currently, a user who wants the convenience of instant messaging has no control over when and what types of messages are delivered.

For example, a user may be on the telephone or may be conducting an instant message session. The user does not wish to be interrupted by unrelated instant messages, but would welcome instant messages pertaining to the topic of the phone call or instant message session. Current instant message filtering systems do not provide ways to refine the control based on the context of messages received.

Instant messaging systems have partially addressed the issue of controlling incoming instant messages. Currently, two methods are commonly employed. The first allows the user to specify persons from whom instant messages will or will not be accepted. This approach allows the user to stop a person from sending instant messages but does not allow the user to specify what types of messages the user will accept or when the user will accept them.

The second method currently used for instant messaging control uses a rating system for instant messaging content. The user can mark an incoming message as undesirable because of unacceptable content. Certain criteria are then attached to the recipient's account that associates a rating to the sender's collective warnings. If the warning level reaches a threshold, that sender may no longer send instant messages to the user. This solution only serves to generally rate the sender's content for appropriateness and does not provide any other form of message filtering.

What is therefore needed is a system and associated method to filter incoming instant messages by context. The need for such a system has heretofore remained unsatisfied.

### SUMMARY OF THE INVENTION

The present invention satisfies this need, and presents a system, a computer program product, and an associated method (collectively referred to herein as “the system” or “the present system”) for filtering instant messages by context. The present system allows users to define a context or set of contexts that describe the type of messages they are willing to receive. The user typically creates a context profile that describes their type of work, projects, organizations, interests, etc. A user can choose to display or hide those contexts to the sender.

Contexts can also be part of a predetermined time profile. A time profile for each context can be automatically updated according to a programmatic link to the user's calendar. With the information available on the user's calendar, the present system would automatically either restrict messages based on recipient, context, or both. For example, the present system might restrict the messages being received during a meeting to only those people invited to that meeting, restrict the incoming messages by predefined context entries, or both. The context could be determined by reading a category field in the user's calendar entry, by a customized context field in the calendar entry, or by prompting the user when the calendar entry becomes active.

The user can select or activate one or more of his predefined contexts according to his current type of work or situation. The sender can then see a list of the recipient's contexts and match the outgoing message to one of those contexts. The present system then delivers the message according to the recipient's profile. Through the profile, the recipient can choose whether a message is delivered immediately, delayed, rejected, or transformed according to the context profile. Transforming the message allows the user to forward the message to a third party or reply to the sender with an automated message.

The automated message may state, for example, that the selected context is not currently active and the message will be delivered when it becomes active or it may be customized to the specific sender. The purpose is that an automated message could be customized to the sender. For example, the automated message might say “Hello [SenderName], you should be aware that John Doe is now handling all Telephone related issues. Thanks”, where [SenderName] would be replaced by the sender's actual name. This way the message is dynamic and customized to each person who sends a matching message. In addition, the user may create an “urgent” context, allowing system 10 to deliver all urgent messages immediately.

Using context filters allows the recipient to avoid interruptions by messages that are not related to the work or activity in which they are currently engaged, and allows the user to receive only messages that relate to the user's context. The present system essentially filters out the types of messages desired based on user defined context criteria.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system and method for filtering instant messages by context of the present invention can be used;

FIG. 2 is a block diagram illustrating the top-level operational components of the contextual filtering system of FIG. 1;

FIG. 3 is a process flow chart illustrating a method of creation of context criteria within a user's profile by the contextual filtering system of FIGS. 1 and 2;

FIG. 4 is an exemplary display screen illustrating a user interface for the contextual filtering system of FIGS. 1 and 2;

FIG. 5 is comprised of FIGS. 5A and 5B, and represents an exemplary display screen illustrating the active context status display for the contextual filtering system of FIGS. 1 and 2;

FIG. 6 is a process flow chart illustrating a method of displaying context criteria to a message sender by the contextual filtering system of FIGS. 1 and 2;

FIG. 7 is comprised of FIGS. 5A and 5B, and represents is an exemplary display screen illustrating the method of displaying context criteria to a message sender by the contextual filtering system of FIGS. 1 and 2; and

FIG. 8 is a process flow chart illustrating a method of message filtering by the contextual filtering system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

E-mail (electronic-mail): The transmission of memos and messages over a network. Within an enterprise, users can send mail to a single recipient or broadcast it to multiple users. Mail is sent to a simulated mailbox in the network mail server or host computer until it is interrogated and deleted.

Instant Messaging: A computer conference using the keyboard (a keyboard chat) over the Internet between two or more people. Instant messaging (IM) is not a dial-up system like the telephone; it requires that both parties be on-line at the same time.

Internet: A collection of interconnected public and private computer networks that are linked together with routers by a set of standards protocols to form a global, distributed network.

PDA: (Personal Digital Assistant) A handheld computer that serves as an organizer for personal information. It generally includes at least a name and address database, to-do list and note taker. PDAs can use a stylus or thumb keyboard for input to select menu items and to enter printed characters. The unit may also include a small on-screen keyboard that is tapped with the pen. Data are synchronized between the PDA and desktop computer via cable or wireless transmission.

SMS (Short Messaging System or Short Message Service): A feature that allows users to receive or transmit short text messages using a wireless phone. Using SMS, a short alphanumeric message up to 160 characters can be transmitted to a mobile phone that displays the message as a pager would.

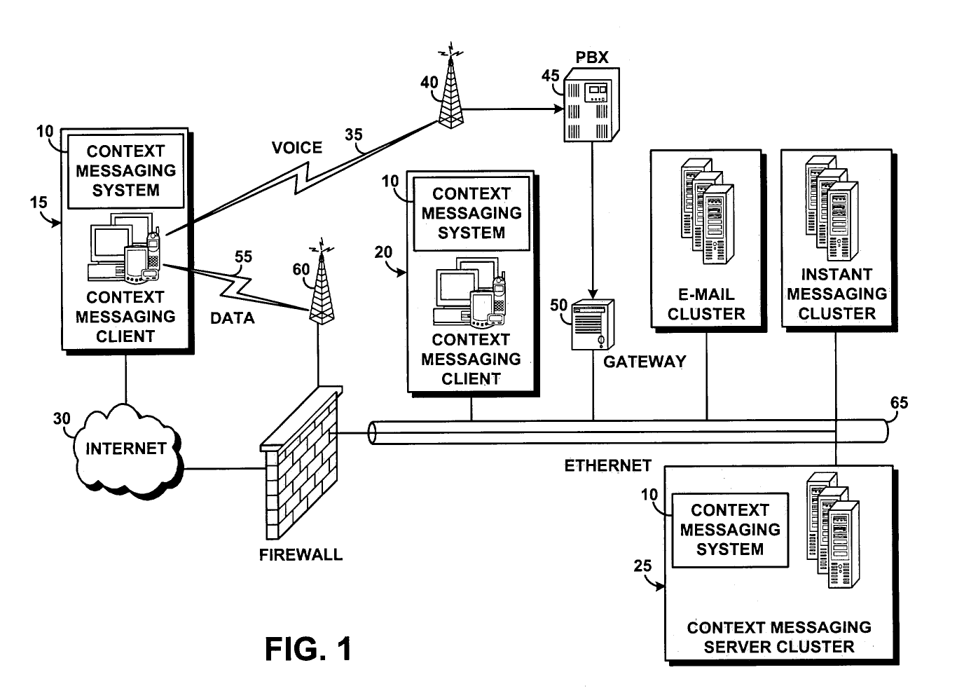

FIG. 1 portrays an exemplary overall environment in which a context messaging system 10 and associated method for filtering instant messages by context according to the present invention may be used. System 10 includes a software programming code or computer program product that is typically embedded within, or installed on a computer, workstation, laptop, PDA or other wireless handheld device, cell phones, etc., as represented by context messaging clients 15, 20. For illustration purpose only, context messaging client 15 is represented as a wireless device, while context messaging client 20 is represented as a computer, workstation, etc.

The function performed by system 10 can be implemented in a server-side system, such as context messaging server cluster 25. System 10 can also be added to any instant messaging application to extend the instant messaging application's function to include context messaging. Alternatively, system 10 can be implemented separately. System 10 can be saved on a suitable storage medium such as a diskette, a CD, a hard drive, or like devices.

The context messaging client 15 communicates with other computers or networks of computers through various paths such as: the Internet 30; wireless communication as represented by voice transmission 35 through antenna 40, PBX 45, and gateway 50; or data transmission 55 through antenna 60 and the Internet 30 or Ethernet 65. The context messaging client 20 may also be associated with such other computers in a Local Area Network (LAN) or a Wide Area Network (WAN) through Ethernet 65.

The message originates at, for example, either context messaging client 15 or 20 using system 10 and is deposited at context message server cluster 25. The message can remain at context message server cluster 25 until the message's context becomes active.

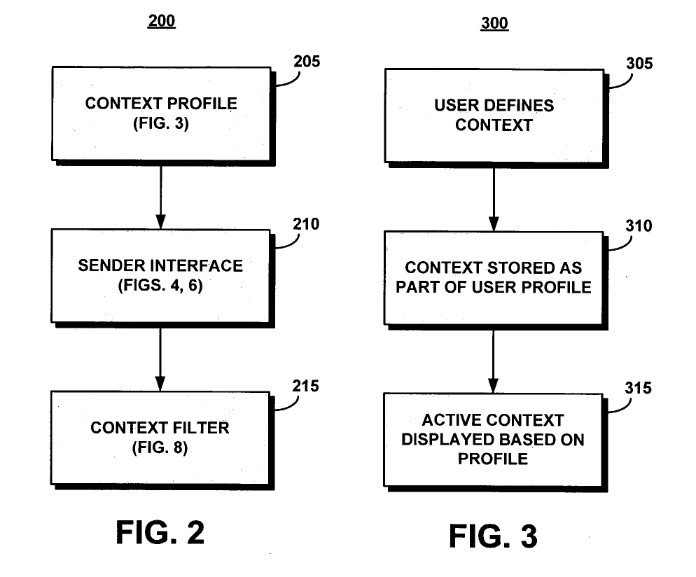

FIG. 2 illustrates the three main components of system 10. These components comprise: a context profile 205, a sender interface 210, and a context filter 215. The method operation 300 of context profile 205 is illustrated in the process flow chart of FIG. 3.

With reference to FIG. 3, the user defines contexts acceptable for receiving messages at block 305. System 10 stores this context as part of the user profile at block 310. System 10 then displays the current active context to the user based on the user profile at block 315.

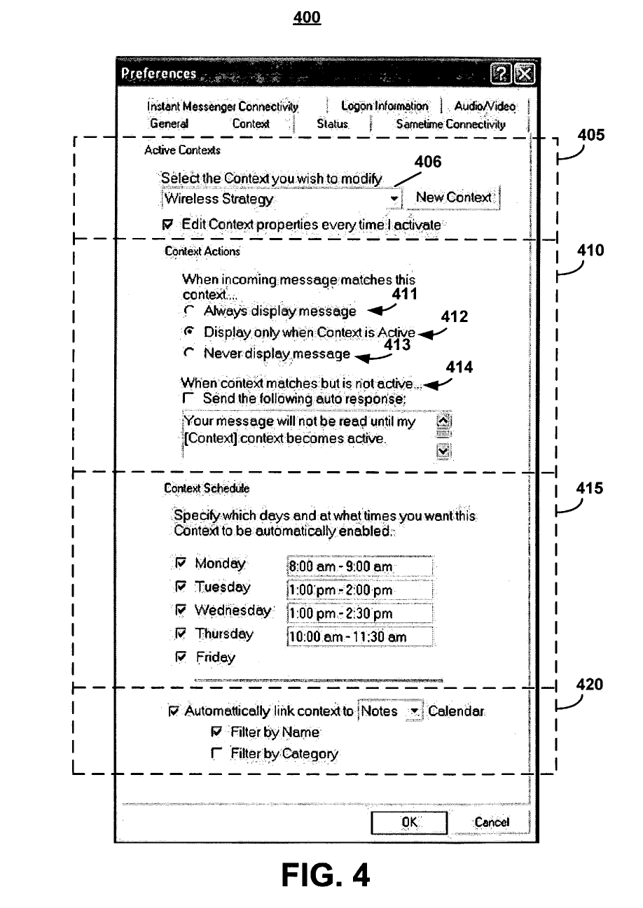

A possible user interface 400 for defining the context profile 205 is shown in FIG. 4. This user interface 400 illustrates but does not limit the capabilities of system 10. For each context 405 the user creates within the user interface 400, the user may enter a context name 406.

In a feature of system 10, the user may also specify context actions 410; these are the responses of system 10 to incoming messages matching context 405. As illustrated, the user may select one of four responses to an incoming message. An incoming message that matches context 405 can either be displayed under all conditions:

(1) it can always be displayed, 411;

(2) it can be displayed only when the context is active, 412;

(3) it can never be displayed, 413; or

(4) it can trigger an automatic response, 414.

As seen in context actions 410, the user can specify a context that allows reception of instant messages under all circumstances, for example an “urgent” context, by selecting “Always display message”. This allows the user to receive critical instant messages regardless of context. The user may extend the ability to send “urgent” messages to a select few, or may allow everyone to send “urgent” messages.

The automatic response seen in context actions 410 can be used to translate the incoming instant message to another type of message. The user can instruct system 10 to forward any incoming instant message pertaining to a context 405 to a third party with a customized explanatory note. System 10 could then automatically send a message to the message originator explaining that the message had been forwarded to the third party with a reason for forwarding the message.

System 10 can also convert the instant message to email, SMS, or a format other than instant message and optionally notify the sender that the message was converted as such. This feature of system 10 allows instant messages to be forwarded to the appropriate person without disturbing the user.

Another form of message translation allows the user to instruct system 10 to automatically respond to each incoming message that is not displayed. This automatic response would inform the message originator that the message does not meet the recipient's active context criteria and the message will be delivered when the selected context becomes active.

In another feature of system 10, the user may determine the context schedule 415 for which context 405 will be active and create a calendar link 420 to the user's calendar for the context 405. The user is not required to manually change the status of each context from active to inactive; system 10 performs this automatically as defined by the context schedule 415 or the user's calendar.

Within the calendar link 420, the user may also filter the context 405 by criteria, such as name or category. The filtering feature makes use of any names attached to activities in the user's computer calendar. To filter by name, system 10 notes, for example, the people invited to a meeting and limits instant messaging during meeting time to only those people invited to the meeting. This illustrates the capability of system 10 to manage an exception rule not defined as a context.

Most computer calendars have a “category” field. Through the category field, the user can change the context according to the category listed for an event on the calendar. The user may also have field named “context” in the calendar that is customizable. By linking to the user's calendar, system 10 can monitor the events on the calendar. System 10 can then alert the user a predefined amount of time before an event (e.g., a meeting) and prompt the user for any desired changes in context status. This feature of system 10 extends context capability to the user's calendar. System 10 could use a form of knowledge management techniques or data mining to automatically change, or to suggest to the user to change, a context based on the results of that knowledge management function. A “smart agent” would analyze the incoming (or sender's) message for certain key words and constructs and attempts to automatically pick a matching context. In this case, the instant message filtering system could work independently of any outside servers, i.e., the sender would not need to have the filter program installed, and therefore would not see the contexts, but the recipient could still filter the messages.

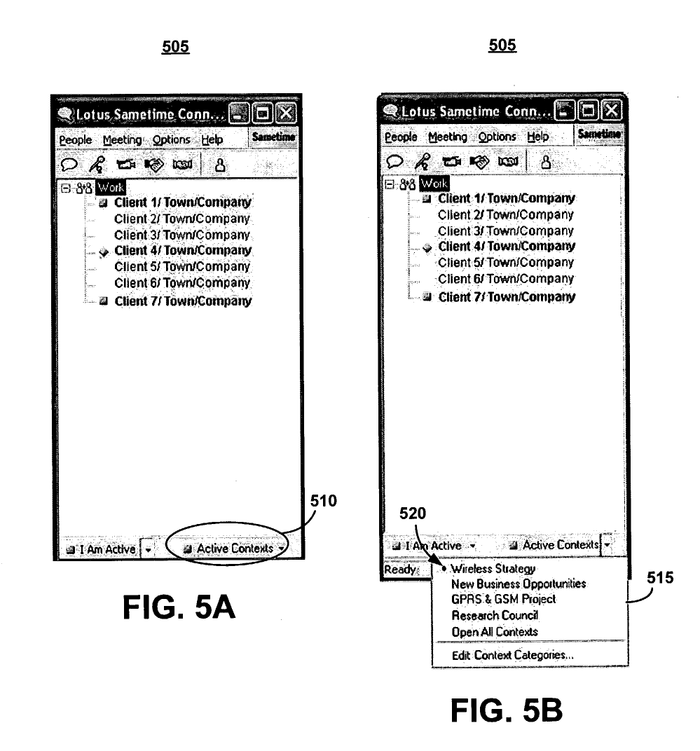

FIG. 5 (FIGS. 5A, 5B) illustrates a method for displaying the active contexts to the user, and represents an exemplary display screen 505 that illustrates the active context status display for system 10. The user's instant message screen 505 is shown with active contexts pull-down menu 510 (FIG. 5A). The expanded active contexts pull-down menu 515 (FIG. 5B) lists all contexts defined by the user. Active contexts are designated by a symbol, such as symbol 520 next to the active context “Wireless Strategy”. One or more contexts may be active at any one time.

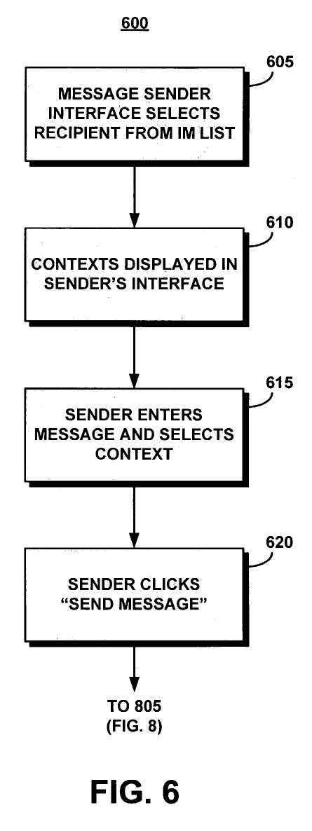

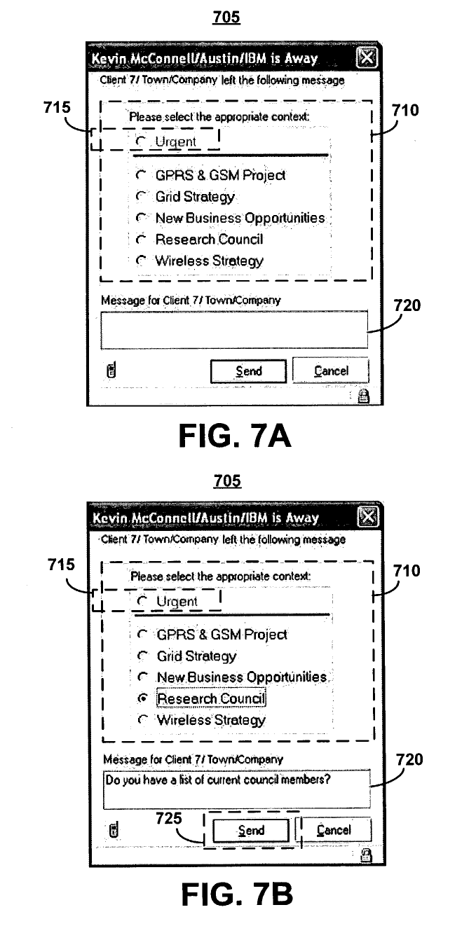

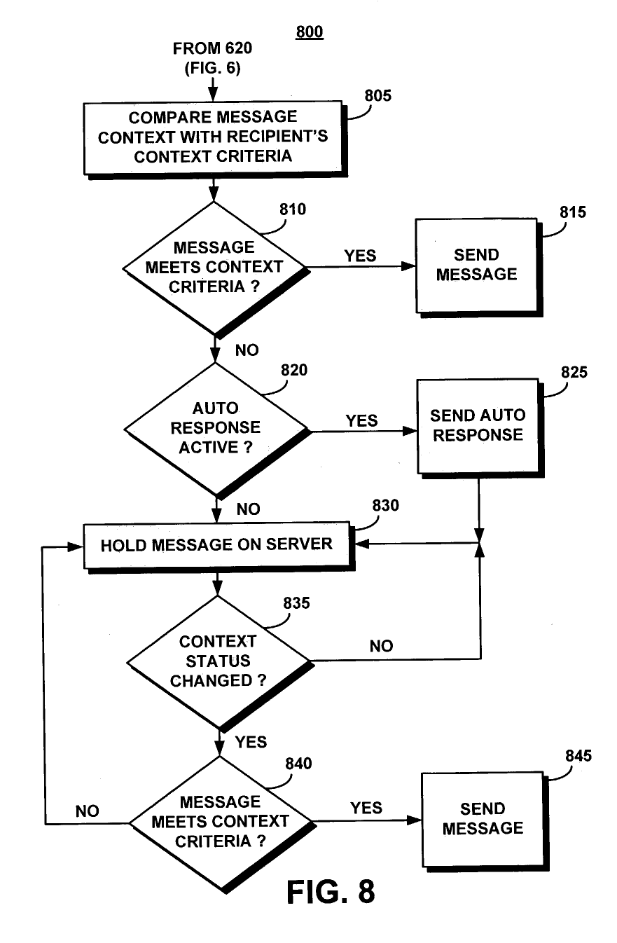

FIG. 6 illustrates a method of operation 600 of sender interface 210 (FIG. 2). The message sender interface 210 selects from the instant message list a recipient for the message at block 605. At block 610, system 10 displays to the sender possible contexts for the message based on the recipient's context profile stored on the context messaging server cluster 25. The sender enters the instant message and selects the appropriate context at block 615. The sender then clicks a button such as “send message” at block 620.

FIG. 7 (FIGS. 7A, 7B) illustrates a possible message sender interface 705 for system 10. The message sender interface 705 contains a context window 710 that displays all relevant contexts to the message sender interface 210. Included in the context window 710 is an “Urgent” context button 715 that allows immediate message delivery regardless of context status. After typing the message in the message window 720, the user selects a context such as “Research Council” in context window 710. The user may select more than one context, if applicable. The user then clicks on the “send” button 725 to send the message.

The user can specify whether he or she will allow the sender to choose more than one context in a single message, or whether the user will only allow the sender to select one context per message. To this end, the user could use, for example, radio buttons or check boxes.

FIG. 8 illustrates an exemplary method of operation 800 of the context filter 215 (FIG. 2). Method 800 is initiated when the message sender interface 210 sends an instant message with context (block 620, FIG. 6). System 10 then compares the context of the message with the recipient's context profile at block 805.

If the context of the message meets the recipient's context criteria at decision block 810, system 10 sends the message to the recipient at block 815. Context criteria are met if the context of the message is currently active or if the context is open to all messages such as an “urgent” context might be. If the context of the message does not meet the recipient's context criteria, system 10 checks the automatic response status at decision block 820.

If the automatic response has been selected, system 10 sends the automatic response as defined by the recipient (block 825). The automatic response might notify the sender that the message will be delivered when the selected context becomes active. System 10 might also forward the message to a third party as defined by the recipient's context criteria.

At block 830, system 10 holds the message on the context message server cluster 25 (FIG. 1). Throughout a predetermined period, such as a day, the context criteria within the message recipient's profile change according to previously defined time and calendar constraints. In addition, the user may manually change active contexts.

System 10 checks the context status at decision block 835. If the context status has changed, system 10 checks whether the message meets the current context criteria at decision block 840. If the message meets the current context criteria, system 10 sends the message to the recipient at block 845.

If, however, it is determined at decision step 840 that the message does not meet the current context criteria, system 10 returns to block 830 and holds the message until it can be delivered according to context criteria.

System 10 releases messages as soon as a context associated with the message is activated by the recipient. The recipient may also select an option such as “open all contexts”; all messages now meet the criteria (block 840) and system 10 releases to the recipient all messages that are being held.

The following example further illustrates the operation of system 10. A user, Tom, accesses his instant messaging client and defines the different contexts in which he works. He instructs his context messaging client to only accept messages related to Wireless Strategy and Emerging Business Opportunities between 10 a.m. and 11:30 a.m. The user, within the profile or at the time of activating a context, can set it so that the context “deactivates” in x units of time (e.g., 25 minutes later, or 2 hours later, etc.) This would be in addition to specifying the specific time the context deactivates (e.g., 11:30 a.m.).

When Sally sends Tom a message at 11:05 a.m., her context messaging client will read Tom's available contexts, prompt Sally to select which contexts apply to her message, and then send the message. The contexts displayed in Sally's context messaging client were automatically provided by system 10 from Tom's context criteria. If Sally's message matches one of the currently active contexts, the message is immediately delivered.

Otherwise, the rules in the Tom's context configuration settings are used to decide how to handle the message. The configuration could specify to perform one of the following functions:

1) delay displaying the message until Tom activates the appropriate context;

2) return unread any message that is either outside a currently active context or that matches a predefined context;

3) send a predefined return message to the sender informing the sender that the delivery of the message has been delayed;

4) convert the message to an email, SMS, or a format other than Instant message, and optionally notify the sender that the message was converted as such; and/or

5) any combination of the above options.

It is to be understood that the specific embodiments of the invention that have been described are merely illustrative of certain application of the principle of the present invention. Numerous modifications may be made to the method for filtering instant messages by context invention described herein without departing from the spirit and scope of the present invention.

What is claimed is:

1. A messaging method for filtering an instant message by context, comprising:
creating a context profile for a recipient of the instant message; and
filtering the instant message based on a selection of the context by a sender of the instant message.

2. The method of claim 1, further comprising displaying the recipient's context profile to a sender of the instant message.

3. The method of claim 2, further comprising storing the recipient's context profile.

4. The method of claim 2, further comprising selectively responding to the instant message.

5. The method of claim 1, wherein creating the context profile comprises the recipient personalizing the context profile.

6. The method of claim 4, wherein selectively responding comprises selecting allowable responses for each context.

7. The method of claim 6, wherein selectively responding further comprises activating the context.

8. The method of claim 6, wherein one of the allowable responses comprises allowing the display of the instant message associated with the context when the context is active or inactive.

9. The method of claim 6, wherein one of the allowable responses comprises displaying the instant message associated with the context only when the context is active.

10. The method of claim 6, wherein one of the allowable responses comprises never displaying the instant message associated with the context.

11. The method of claim 6, wherein one of the allowable responses comprises defining an automatic response when any of the following states is satisfied:
the context is inactive; or
the context becomes active.

12. The method of claim 6, further comprising linking the context to a calendar organizer.

13. The method of claim 6, further comprising linking the context to an organizer.

14. The method of claim 12, wherein filtering the instant message comprises filtering with respect to a name reference in the calendar, for linking to the context.

15. The method of claim 12, wherein filtering the instant message comprises filtering with respect to a category reference in the calendar for linking to the context.

16. The method of claim 3, further comprising comparing the context of the instant message with a recipient's context profile that has been stored.

17. The method of claim 1, further comprising sending the instant message to the recipient if the context is currently active.

18. The method of claim 17, further comprising if the message context is not currently active, responding with an automatic response.

19. The method of claim 1, further comprising sending a pre-defined reply to the sender.

20. The method of claim 1, further comprising releasing the instant message to the recipient when any one of the following conditions is satisfied:
the context becomes active; or
the message is requested by the recipient.

21. A computer program product having instruction codes for filtering an instant message by context, comprising:
a first set of instruction codes for creating a context profile for a recipient of the instant message; and
a second set of instruction codes for filtering the instant message based on a selection of the context by a sender of the instant message.

22. The computer program product of claim 21, further comprising a third set of instruction codes for displaying the recipient's context profile to a sender of the instant message.

23. The computer program product of claim 22, further comprising a storage that stores the recipient's context profile.

24. The computer program product of claim 22, further comprising a fourth set of instruction codes for selectively responding to the instant message.

25. The computer program product of claim 21, wherein the first set of instruction codes personalizes the context profile.

26. The computer program product of claim 24, wherein the fourth set of instruction codes selects allowable responses for each context.

27. The computer program product of claim 26, wherein the fourth set of instruction codes activates the context.

28. The computer program product of claim 26, wherein one of the allowable responses comprises allowing the display of the instant message associated with the context when the context is active or inactive.

29. The computer program product of claim 26, wherein one of the allowable responses comprises displaying the instant message associated with the context only when the context is active.

30. The computer program product of claim 26, wherein one of the allowable responses comprises never displaying the instant message associated with the context.

31. The computer program product of claim 26, wherein one of the allowable responses comprises defining an automatic response when any of the following states is satisfied:
the context is inactive; or
the context becomes active.

32. The computer program product of claim 26, further comprising a fifth set of instruction codes for linking the context to a calendar organizer.

33. The computer program product of claim 26, further comprising a fifth set of instruction codes for linking the context to an organizer.

34. The computer program product of claim 32, wherein the second set of instruction codes filters with respect to a name reference in the calendar, for linking to the context.

35. The computer program product of claim 32, wherein the second set of instruction codes filters with respect to a category reference in the calendar for linking to the context.

36. The computer program product of claim 23, further comprising a sixth set of instruction codes for comparing the context of the instant message with a recipient's context profile that has been stored.

37. The computer program product of claim 21, further comprising a seventh set of instruction codes for sending the instant message to the recipient if the context is currently active.

38. The computer program product of claim 37, wherein the seventh set of instruction codes responds with an automatic response if the message context is not currently active.

39. The computer program product of claim 21, further comprising a seventh responding with an automatic response for sending a pre-defined reply to the sender.

40. The computer program product of claim 21, further comprising a seventh responding with an automatic response for releasing the instant message to the recipient when any one of the following conditions is satisfied:
the context becomes active; or
the message is requested by the recipient.

41. A messaging system for filtering an instant message by context, comprising:
means for creating a context profile for a recipient of the instant message; and
means for filtering the instant message based on a selection of the context by a sender of the instant message.

42. The system of claim 41, further comprising means for displaying the recipient's context profile to a sender of the instant message.

43. The system of claim 42, further comprising a storage that stores the recipient's context profile.

44. The system of claim 42, further comprising means for selectively responding to the instant message.

45. The system of claim 41, wherein the means for creating the context profile personalizes the context profile.

46. The system of claim 44, wherein the means for selectively responding to the instant message selects allowable responses for each context.

47. The system of claim 46, wherein the means for selectively responding to the instant message activates the context.

48. The system of claim 46, wherein one of the allowable responses comprises allowing the display of the instant message associated with the context when the context is active or inactive.

49. The system of claim 46, wherein one of the allowable responses comprises displaying the instant message associated with the context only when the context is active.

50. The system of claim 46, wherein one of the allowable responses comprises defining an automatic response when any of the following states is satisfied:
the context is inactive; or
the context becomes active.
